(19) United States
(12) Patent Application Publication
(10) Pub. No.: US 2014/0168447 A1
(43) Pub. Date: Jun. 19, 2014

(54) Optical Device Including a Mode for Grouping Shots for Use with Precision Guided Firearms

(71) Applicant: TRACKINGPOINT, INC., (US)

(72) Inventors: Douglas Ainsworth Scott, Bracknell (GB); John Francis McHale, Austin, TX (US); Alexander Linn Iles, Austin, TX (US); John Hancock Lupher, Austin, TX (US); Michael Eric Reimers, Austin, TX (US)

(73) Assignee: TRACKINGPOINT, INC., Austin, TX (US)

(21) Appl. No.: 13/718,764

(22) Filed: Dec. 18, 2012

(51) Int. Cl. H04N 5/232

(52) U.S. Cl. CPC H04N 5/23293
USPC 348/169

(57) ABSTRACT

An optical device for use with a firearm includes an image sensor configured to capture visual data corresponding to video of a view area, and includes a display, and a controller coupled to the image sensor and to the display. The controller is configured to provide the video including a visual marker at a previously selected tag location on a target within the video to a display. The controller is configured to reapply the visual marker to the previously selected tag location on the target within the video, shot after shot, when the controller is in a group shooting mode.

### FIELD

The present disclosure is generally related to small arms firearms, and more particularly to an optical device for use with firearms that includes a precision group shooting mode.

### BACKGROUND

A precision guided firearm (PGF) includes a rifle or other firearm and an intelligent digital optical scope that integrates with, and controls the firing of, the PGF. The PGF allows a user to designate or tag a target prior to actually firing on the target, calculates range to the target, and calculates the proper ballistic solution for accurately impacting the target. Once a target is tagged, the intelligent digital optical scope portion of the PGF tracks the target location relative to the barrel position and is coupled to a trigger assembly to control or delay firing until the PGF's barrel is in the proper position to ensure the PGF fires on target based on the calculated ballistic solution.

Shooters, for a variety of reasons, participate in target shooting. A typical scenario is a gun owner taking his/her firearm to a gun range and shooting at targets at various ranges to hone his/her shooting accuracy. One way to test or measure his/her accuracy is by shooting a certain number of shots (i.e., five shots) at a specific location on a target and attempting to group all of the shots as close together as possible on the impacted target. This practice is often referred to as “group shooting.” A shooter may attempt to use a PGF for group shooting; however, designating or tagging a target with a PGF in the presence of human jitter can be difficult. Moreover, designating or tagging the target in the exact same target location, which is desired by practice shooters, competition shooters, and the like, can be difficult, if not impossible.

### SUMMARY

In an embodiment, an optical device for use with a firearm includes an image sensor configured to capture video of a view area, and includes a display, and a controller coupled to the image sensor and to the display. The controller is configured to provide the video including a visual marker at a previously selected tag location on a target within the video to a display. The controller is configured to reapply the visual marker to the previously selected tag location on the target within the video, shot after shot, when the controller is in a group shooting mode.

In another embodiment, a method includes receiving a sequence of video frames of a view area from an optical sensor of an optical device coupled to a firearm. The method further includes applying a visual marker to a previously selected tag location on a target within the sequence of video frames provided to a display of the optical device using a controller of the optical device. The method further includes reapplying the visual marker to the previously selected tag location within the sequence of video frames, shot after shot, when the controller is in a group shooting mode.

In still another embodiment, a precision guided firearm system includes a firearm and an optical device mounted to the firearm. The optical device is configured to capture video frame of a view area and to present the video frame including a visual marker representing a previously selected tag location on a target to a display. The optical device is configured to reapply the visual marker on the previously selected tag location within the display, shot after shot, when the optical device is configured for a group shooting mode.

### BRIEF DESCRIPTION OF THE DRAWINGS

FIG. 1 is a diagram of a sequence of views of a target in a precision competition using a PGF without using a group shooting mode.

FIG. 2 is a diagram of a sequence of views of a target using a PGF including a group shooting mode.

FIG. 3 is a flow diagram of a method of selectively reacquiring a target using an optical device in a group shooting mode after discharge of a PGF according to an illustrative embodiment.

FIG. 4 is a perspective view of an embodiment of an optical device configured to provide a group shooting mode.

FIG. 5 is a block diagram of an embodiment of a system configured to provide a group shooting mode.

In the following discussion, the same reference numbers are used in the various embodiments to indicate the same or similar elements.

### DETAILED DESCRIPTION OF ILLUSTRATIVE EMBODIMENTS

Embodiments of an optical device are described below that can be implemented as a rifle scope configured to mount to a firearm and to interact with a trigger mechanism to provide a PGF system having a group shooting mode. In an example, the optical device is configured to receive a user input (implicit or explicit) to select a location on a target within a view area. The optical device applies a visual tag or marker to a selected location on the target and stores a reference image of the view area including data corresponding to the location of the visual marker in a memory. The optical device then controls a trigger assembly to prevent discharge of the PGF until a center of a reticle displayed within the optical device is aligned to the visual marker. After the user shoots, the optical device determines the location of the visual marker within the reference image, identifies a corresponding location within the current view, and reapplies the visual marker to the corresponding location to assist the user in targeting the same location where the original visual tag or marker was placed.

Various shooting competitions exist for measuring a shooter's skill. One type of shooting competition is called score shooting, where a traditional bulls eye type of target includes scoring rings. In score shooting (accuracy competition), the shooter scores by placing a shot within a particular ring, and the winner is determined based on the shooters' total score results. Another type of competition is a group shooting competition, in which the shooter attempts to place a number of shots on a target as close together as possible, and preferably in exactly the same place on the target. In group shooting, the winning score is determined based on how closely the shots are grouped. Ideally, the user might place multiple shots through a single bullet hole; however, it can be very difficult for the user to demonstrate that level of precision.

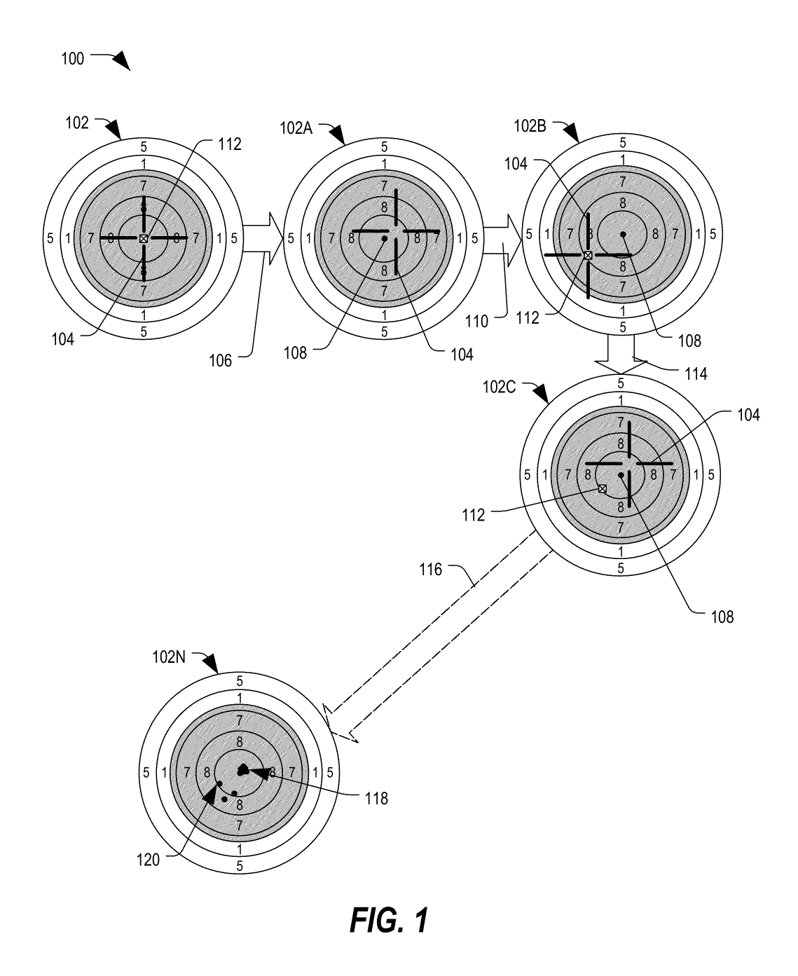

Even when a PGF is used, the user may have difficulty in placing the visual marker or tag at the same location on the target as the location of the originally placed visual marker or tag. One example of a sequence of views of a target used for a precision competition is described below with respect to FIG. 1 where target reacquisition using a PGF is performed manually by the shooter.

FIG. 1 is a diagram 100 of a sequence of views of a target 102 in a precision competition using a PGF without using a group shooting mode. The sequence of views represents changes to the target and/or the image of the target on a display within a digital optical device through a sequence of shots. In this example, a user may apply a visual tag or marker to a selected location on an image of the target within the optical device and, if the optical device is part of a PGF system, the optical device will control timing of the shot to prevent discharge until a reticle is aligned to the visual tag.

At target 102, the user has previously applied a visual marker 112 to a center of target 102, and has now aligned a reticle 104 to the visual marker 112. At this point, if the user is pulling the trigger of the PGF, a controller within the optical device will allow the trigger assembly to release, discharging the PGF and launching the bullet toward the target at the location corresponding to the visual marker. In an example, in response to placement of visual marker 112, the optical device may determine a ballistics solution relative to the selected target and may adjust the view area and/or the reticle position to reflect the ballistics solution. In the illustrated example, the reticle 104 is not aligned with the visual marker (either due to the calculated ballistic solution or due to human jitter), so the user will realign the reticle 104 to the visual marker 112 before firing (at 106), which results in target 102A.

On target 102A, a bullet hole 108 is depicted, representing impact of the projectile at or very near the location where visual marker 112 was placed on target 102. Upon discharge, visual marker 112 disappears, and recoil, shooter movement, shooter preference, and/or human jitter cause reticle 104 to shift away from the selected target location.

In a group shooting competition, the user attempts to shoot multiple shots in as close a grouping as possible. In this example, at 110, the user attempts to place visual marker 112 at the same location as bullet hole 108. To place the visual marker 112, the user aligns the reticle 104 to the desired location and either presses or releases a button (or maintains the center of the reticle on the desired location for a period of time, e.g., directed aiming) to place visual marker 112 on target 102B.

At 114, the user placed the visual marker 112. In this example, the visual marker 112 is placed at a location that is offset from bullet hole 108 as shown on target 102C. While the user (shooter) may have wanted to place the visual marker 112 in the same location where it was previously placed, the elements of the shooting event, the distance, human error, and/or human jitter can make it very difficult for the user to re-apply the visual marker to the same location. After placement of visual marker 112, once again, due to human jitter, movement, preference, and/or calculation of the ballistics solution, reticle 104 is shifted relative to the placement location of visual marker 112. To shoot, the user aligns reticle 104 to visual marker 112 and pulls the trigger. This process is repeated multiple times (N times) for a group shooting competition (as indicated by dashed arrow 116), resulting in a target 102N, which has a cluster of closely placed bullet holes generally indicated at 118 and several shots that are spaced from the cluster by a small distance, including bullet hole 120 that corresponds to placement of visual marker 112 on target 102C. Target 102N is intended to depict the difficulty in reacquiring the target location and the effect that this difficulty may have on the desired clustering of the shots.

As discussed above, the optical device can be configured to capture and store a visual image (frame) of a view area including the visual marker in response to target tag selection. After discharge of the PGF, the optical device can use the stored image to determine the location of the visual marker in the stored image and to identify the corresponding location within the current image.

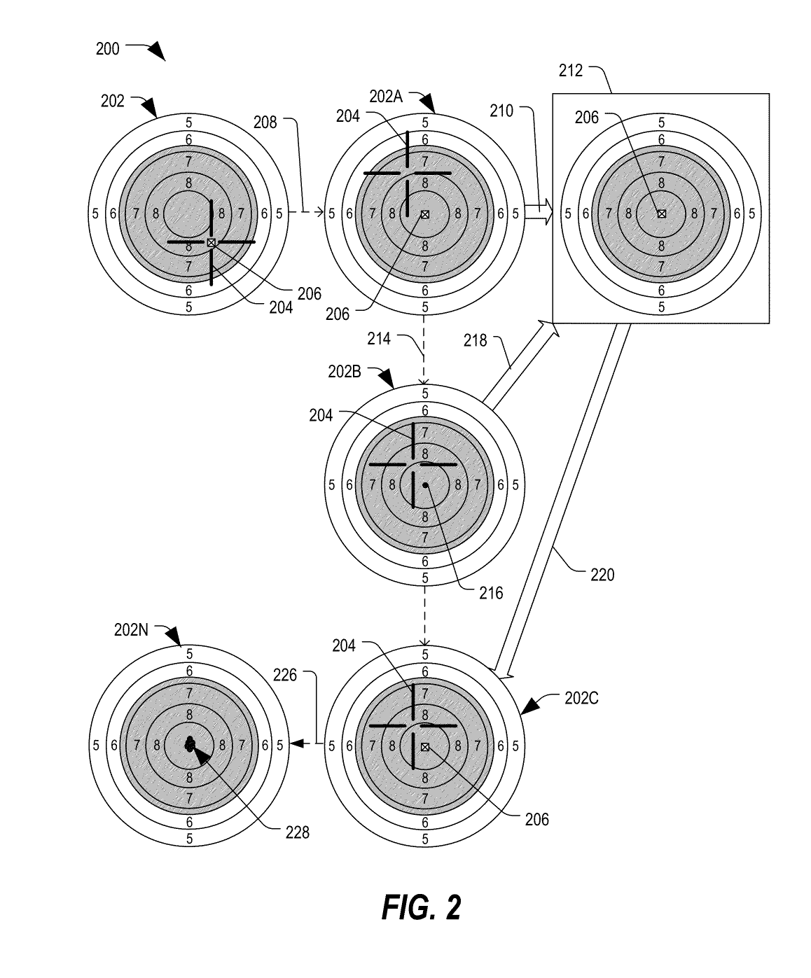

FIG. 2 is a diagram of a sequence of views 200 of a target 202 using a PGF including a group shooting mode. During a target tagging process, the user aligns the reticle 204 to a location on target 202. At 208, the user presses or releases a button or the optical device detects a directed aiming event to apply a visual marker 206 to a selected location on target 202A. As depicted in 202A, the user has selected a location at a center of target 202A, attaching visual marker 206 at the selected location.

At 210, the optical device captures a reference image 212 of target 202A including the designated position of the visual marker 206, which can be stored in memory. At 214, the user fires a shot at the target. In a particular example, the optical device is part of a PGF, and the optical device controls operation of a trigger assembly to prevent discharge of the PGF until the user has aligned reticle 204 to visual marker 206. Accordingly, as depicted by target 202B, shooting the PGF leaves a bullet hole 216 approximately at the location of visual marker 206.

At 218, the optical device correlates the current view of target 202B to the designated position of the visual marker 206 in the reference image 212 to identify the corresponding location on the target 202B in the current view area. In a particular example, the visual marker or tag is a visual representation of a user-designated location on a target. The user-designated location on the target can be resolved by the optical device to a sub-pixel resolution, i.e., a fraction of a pixel. Accordingly, the visual tag or marker can be reapplied to the tag location, because the tag location can be reacquired based on the sub-pixel resolution. If the aim point of the user changes by as much as a fraction of a pixel (such as a third of a pixel), a processor of the optical device can detect such motion and the same sub-pixel resolution can be used to reacquire the tag location. The visual representation presented on the target within the display is unassociated with the sub-pixel location, but rather is a representation that spans multiple pixels and that generally corresponds to that sub-pixel position.

At 220, the optical device automatically reapplies the visual marker 206 at the corresponding location in the current view as shown on target 202C, exactly where the user previously applied the visual marker 206 (i.e., on target 202A). The user once again aligns the reticle to visual marker 206 on target 202C by adjusting an orientation of the PGF and shoots at the target by pulling the trigger. As represented by dashed line 226, the optical device may reacquire the location of visual marker 206 multiple times and the user may fire the PGF toward the location of the visual marker 206 a corresponding number of times. Thus, shot after shot, the optical device maintains (or reacquires the designated location and reapplies) the visual marker on the same location on the target, and the PGF may be fired multiple times, resulting in target 202N, which has a relatively close cluster of bullet holes, generally indicated at 228.

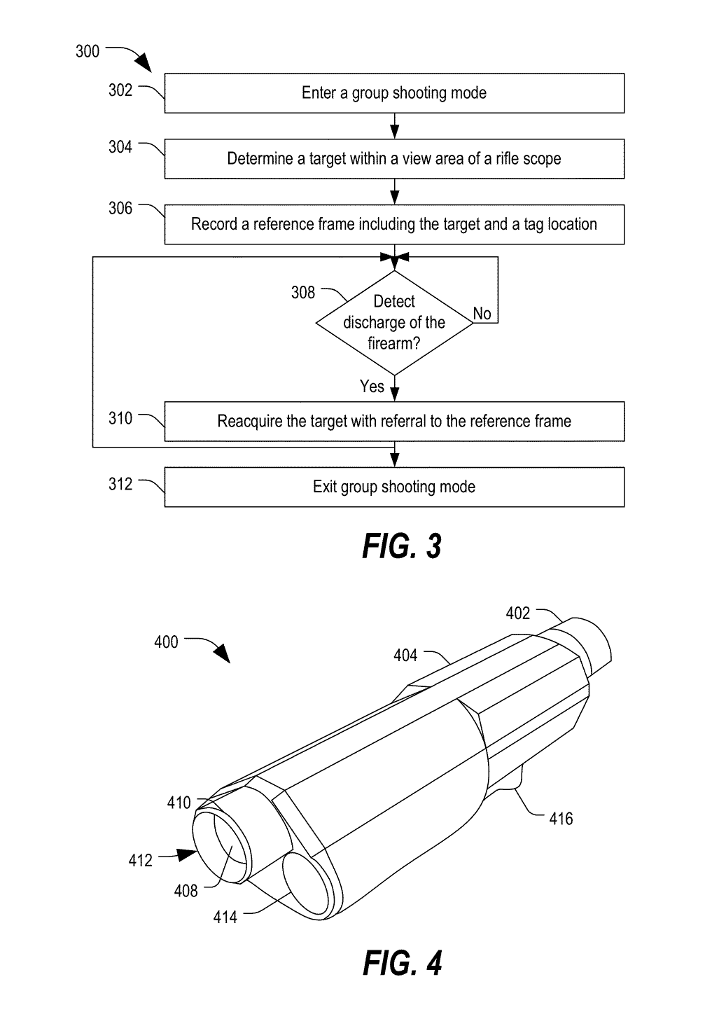

Unlike the bullet holes 118 and 120 resulting from manual reacquisition of the location of visual marker 112 on target 102 in FIG. 1, the resulting cluster of bullet holes 228 in the sequence of views 200 of FIG. 2 provide a closer grouping of shots. While the above-discussion has described operation of the optical device with respect to the outcome relative to a target, the optical device reacquires the location of visual marker 206 by comparing a current view to a previously stored view of the target (a stored reference frame). One possible example of an embodiment of a method of automatically placing a visual tag at the same location on a target that the user previously tagged is described below with respect to FIG. 3.

FIG. 3 is a flow diagram of a method 300 of reacquiring a target with reference to a reference frame when in a group shooting mode. At 302, the user controls the optical device to enter a group shooting mode. In general, a user may interact with a user interface, such as one or more buttons on the optical device or on the grip of the PGF or an interface of an electronic device (such as a smart phone or personal digital assistant (PDA) that is configured to communicate with the optical device) to cause the optical device to enter the group shooting mode. Additionally, the optical device may be configurable for one or more types of shooting competitions, such as group shooting, scoring, and so on.

Advancing to 304, the user designates a target within a view area of the optical device. Target designation may include the user directing the optical device toward the view area and interacting with at least one button on the optical device or on the grip of the PGF to manually place a visual marker or tag on a selected location on the target (such as visual marker 206 in FIG. 2). In an example, the user tags the target relative to the displayed image; however, the designated position on the target corresponds to a pixel location. The pixel location becomes unassociated with the image presented to the user in the display, but rather becomes associated with a sub-pixel resolution of the image, so that the timing of the shot and the ballistics can be calculated using the sub-pixel resolution of the imaging. As used herein, the term “sub-pixel” refers to a fraction of a single pixel, allowing for a target designation resolution that exceeds the visual resolution of the display. In an example, the visual marker or tag is a digital image or indicator on a display within the optical device that assists the user in his or her shot accuracy relative to the selected location on the target, but that is a representation of the sub-pixel target designation. In another example, instead of the user manually designating the location on the target, the location on the target may be inferred by a processor of the optical device in response to detecting a directed pointing or directed aiming by the user. Once the target is selected, the method proceeds to 306.

At 306, the optical device records a reference frame (such as reference image 212 in FIG. 2) including the target and tag location (sub-pixel information). Specifically, the optical device records the reference frame with the tag location indicating the user-designated sub-pixel location on the target in a memory. Advancing to 308, if the optical device detects a shock event that is not a discharge of an associated firearm, the method 300 returns to 308 to wait for a shot. At 308, if discharge of the PGF is detected, the method advances to 310 and the optical device reacquires the target with referral to the reference frame. In an example, a processor within the optical device captures a current image of the view area and compares it to the stored reference frame to determine the tag location and reapplies the visual marker to the location on the target based on tag location in the reference frame. The method 300 then returns to 308 to wait for another shot. Alternatively, the user may press a button to exit the group shooting mode at 312.

In general, the optical device described above may be implemented in a variety of different shapes and housings. One possible embodiment of an optical device including a competition mode is described below with respect to FIG. 4.

FIG. 4 is a perspective view of an embodiment of an optical device 400 including a group shooting mode. Optical device 400 includes an eyepiece 402 through which a user may look to see a view area. Optical device 400 further includes a housing 404 that defines an enclosure sized to secure circuitry and sensors, such as optical sensors, motion and/or orientation sensors, and the like. Circuitry within housing 404 includes image processing circuitry configurable to digitally magnify and process optical data captured by the optical sensors, receive a target selection input (implicit or explicit), apply a visual marker or tag to a location on the target in response to the target selection input. In a group shooting mode, circuitry is configured to capture an image including a and to store the image and a tag location on the target in a memory as a reference frame. After discharge of the PGF, circuitry within housing 404 is configured to compare a current image to the reference image to determine the tag location (sub-pixel designation) corresponding to the visual marker in the reference frame and to reacquire the tag location and apply the visual marker to the tag location in the current view (i.e., to reacquire the target).

Optical device 400 further includes a lens portion 410 including an objective lens for focusing light toward the optical sensors. Optical device 400 further includes a laser rangefinder transmitter 412 and a laser rangefinder receiver 414 for transmitting a laser beam toward the aim-point and for receiving reflections of the laser beam to determine a distance to the target. Additionally, optical device 400 includes one or more ports 416 configurable to couple to an external device, such as a smart phone, laptop or tablet computer, or other computing device to transfer information and/or instructions, bi-directionally. In an example, optical device 400 may receive one or more instructions or upgrades through the one or more ports, which instructions or upgrades can be used for determining the location of the visual marker and/or for reacquiring the visual marker location for reapplication of the visual marker in a current view.

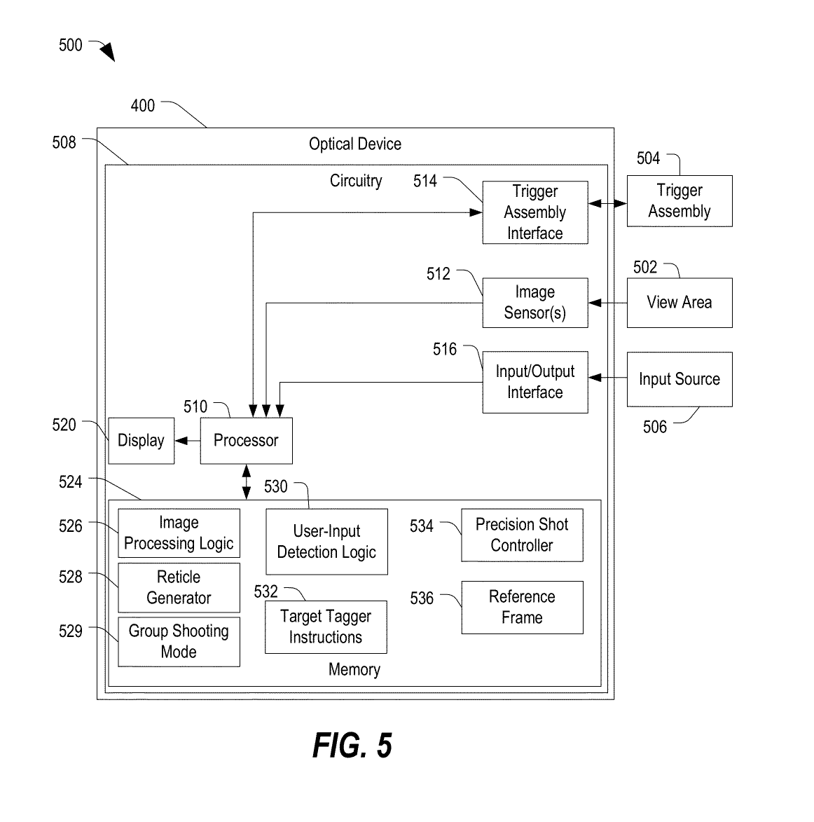

In general, the optical device 400 is an optical device that can be utilized with a variety of different firearms, including, but not limited to rifles and air guns. One possible implementation of the optical device 400 is described below with respect to FIG. 5.

FIG. 5 is a block diagram of an embodiment of a system 500 including an optical device 400 configured to provide a group shooting mode. Optical device 400 is coupled to a trigger assembly 504 of a PGF and to an input source 506.

Optical device 400 includes circuitry 508 including one or more image sensors 512 configured to capture images of a view area 502. The one or more images sensors 512 are coupled to a processor 510, which is coupled to a display 520 configured to present the image data to a user (for example through lens 402 in FIG. 4). Processor 510 is also coupled to a memory 524 that is configured to store instructions and image data (such as a reference image 212 in FIG. 2). Circuitry 508 further includes a trigger assembly interface 514 coupled to the processor 510 and configured to couple circuitry 508 to trigger assembly 504 to provide control signals to selectively control timing of the discharge of the system 500. Processor 510 is further coupled to input/output interface 516, which is coupled to input source 506, which may be a button on optical device 400 or on an associated firearm or which may be a computing device, such as smart phone or tablet computer. The input/output interface 516 may receive signals corresponding to user inputs, such as a target selection input to specify a selected location on a target within the view area or a mode selection input to alter the operating mode of optical device 400 from a first operating mode to a group shooting mode or some other competition mode.

Memory 524 includes group shooting mode instructions 529 that, when executed by processor 510, cause processor 510 to provide a group shooting mode as described above. Memory 524 includes image processing logic 526 that, when executed, causes processor 510 to capture and store a reference frame 536 and to compare current frames to the stored reference frame 536 to reattach a visual marker to the same location on a selected target, shot after shot. Memory 524 further includes a reticle generator 528 that, when executed, causes processor 510 to produce a digital reticle for presentation with the video frames on display 520 (which is viewable by a user through lens 402.

Memory 524 further includes user-input detection logic 530 configured to detect user selection of a target within the view area 502. In one embodiment, the user may interact with an input source 506 to select a location on a target. Memory 524 includes target tagger instructions 532 that, when executed, causes processor 510 to apply a visual marker or tag to the selected location on the target within display 520 and to store an image including the visual marker or tag as a reference frame 536. Memory 524 also includes a precision shot controller 534 that, when executed, causes processor 510 to control timing of discharge of an associated firearm through control signals to trigger assembly interface 514. In an example, the control signals may prevent trigger assembly 504 from discharging the PGF until a center of the reticle is aligned to the visual marker.

In an example, the user may apply a visual tag to a location on a target. Processor 510 stores reference frame 536 including the sub-pixel tag location in memory 524. Processor 510 then controls timing of the discharge to permit discharge when the user intersects the center of the reticle with the sub-pixel tag location represented by the previously set tag or visual marker on the display 520. After the user shoots the PGF when in a group shooting mode, processor 510 executes image processing logic 526 to compare a current video frame to reference frame 536 to identify the tag location of sub-pixel tag location in reference frame 536 and to identify the corresponding location in the current video frame. Once the corresponding location is identified, image processing logic 526 automatically reapplies the visual marker to the corresponding location in the current frame, making it unnecessary for the user to manually re-apply the tag or visual marker to the target.

In an embodiment, after the user shoots the PGF when in the group shooting mode, the user may attempt to reapply the visual marker or tag to the same location on the target. In an example, the user may press a button to initiate a tagging sequence and release the button to apply the visual marker or tag to an object in the view area of the optical device 400. Upon application of the visual marker, processor 510 may execute image processing logic 526 to compare a current location of the visual marker in the current video frame to the location of the visual marker in the reference frame 536 and may refine the current location to align the visual marker or tag to the tag location associated with the reference frame 536. In an example, image processing logic 526 determines a difference between the current designated tag location and the tag location of the reference frame 536 and, if the difference is less than a threshold difference, adjusts or refines the currently designated tag location to match the tag location in reference frame 536. Otherwise, if the difference is greater than a threshold difference, image processing logic 526 may cause processor 510 to retain the currently designated tag location with no adjustment.

In conjunction with the systems, optical devices, and methods described above with respect to FIGS. 1-5, an optical device is disclosed that is configured to provide a group shooting mode. In the group shooting mode, the optical device maintains a visual marker or tag on the same location on a target, shot after shot. In an embodiment, the optical device stores a reference image of the target and identifies the location of the visual marker in the current view based on the location of the visual marker in the reference image to place the visual marker at the same location, shot after shot.

Although the present invention has been described with reference to preferred embodiments, workers skilled in the art will recognize that changes may be made in form and detail without departing from the scope of the invention.

What is claimed is:

1. An optical device for use with a firearm, the optical device comprising:
an image sensor configured to capture video corresponding to a view area;
a display; and
a controller coupled to the image sensor and to the display, the controller configured to provide the video including a visual marker at a previously selected tag location on a target within the video to a display, the controller configured to reapply the visual marker to the previously selected tag location on the target within the video, shot after shot, when the controller is in a group shooting mode.

2. The optical device of claim 1, further comprising:
a memory coupled to the controller; and
wherein the controller is configured to store a reference frame of the target including the previously selected tag location corresponding to sub-pixels of the target in the memory.

3. The optical device of claim 2, wherein the controller is configured to compare a current frame of the video to the reference frame and to automatically reapply the visual marker to the previously selected location on the target based on the previously selected tag location associated with the reference frame.

4. The optical device of claim 2, wherein the controller is configured to receive a user input identifying a new selected location for placement of the visual marker within the video, the controller configured to compare the new selected location to the previously selected tag location and to selectively adjust placement of the visual marker to correspond to the previously selected tag location.

5. The optical device of claim 3, further comprising an input interface coupled to the controller and configured to receive a signal corresponding to a user input.

6. The optical device of claim 5, wherein the signal corresponds to a mode selection input to change from a first operating mode to a group shooting mode.

7. The optical device of claim 1, wherein the controller comprises a processor and a memory accessible to the processor, the memory configured to store instructions that are executable by the processor to reapply the visual marker to the previously selected tag location on the target in the video, shot after shot.

8. A method comprising:
receiving a sequence of video frames of a view area from an optical sensor of an optical device coupled to a firearm;
applying a visual marker to a previously selected tag location on a target within the sequence of video frames provided to a display of the optical device using a controller of the optical device; and
reapplying the visual marker to the previously selected tag location on the target within the sequence of video frames, shot after shot, when the controller is in a group shooting mode.

9. The method of claim 8, wherein reapplying the visual marker to the previously selected tag location within the sequence of video frames comprises:
storing a reference frame from the sequence of video frames in a memory of the optical device using the controller, the reference frame including the target and the previously selected tag location.

10. The method of claim 9, wherein reapplying the visual marker comprises:
after each shot:
determining the previously selected tag location of the visual marker within the reference frame;
identifying a corresponding location in a current frame of the sequence of video frames; and
reapplying the visual marker to the corresponding location.

11. The method of claim 9, wherein reapplying the visual marker comprises:
after each shot:
receiving a second user input indicating a new selected tag location within the sequence of video frames;
comparing the new selected tag location within a current frame to the previously selected tag location in the reference frame; and
selectively adjusting placement of the visual marker to correspond to the previously selected tag location.

12. The method of claim 11, wherein the new selected tag location is selectively adjusted when a difference between the new selected tag location and the previously selected tag location is less than a pre-determined threshold.

13. The method of claim 8, wherein receiving the user input comprises receiving a signal corresponding to one of a button press and a button release when a center of a reticle is aligned to the previously selected tag location within the sequence of video frames.

14. The method of claim 8, wherein, before receiving the user input, the method further comprises:
receiving a selection input corresponding to selection of the group shooting mode: and
changing an operating mode of the controller from a first operating mode to a group shooting mode.

15. The method of claim 14, further comprising:
receiving a second selection input; and
exiting the group shooting mode in response to receiving the second selection input.

16. A precision guided firearm system comprising:
a firearm; and
an optical device mounted to the firearm, the optical device configured to capture video of a view area and to present the video including a visual marker representing a previously selected tag location on a target to a display, the optical device configured to reapply the visual marker on the previously selected tag location within the display, shot after shot, when the optical device is configured for a group shooting mode.

17. The precision guided firearm system of claim 16, wherein the optical device comprises:
a memory coupled to the controller; and
wherein the controller is configured to store a reference frame of the target including the previously selected tag location in the memory.

18. The precision guided firearm system of claim 17, wherein the controller is configured to compare a current frame of the video to the reference frame and to automatically reapply the visual marker to the previously selected tag location on the target based on the reference frame.

19. The precision guided firearm system of claim 17, wherein the controller is configured to receive a user input to apply the visual marker to a new selected tag location within the video, the controller configured to compare the new selected tag location to the previously selected tag location on the target in the reference frame and to adjust placement of the visual marker to correspond to the previously selected tag location.

20. The precision guided firearm system of claim 16, wherein the optical device comprises a trigger assembly interface configured to couple to a trigger assembly of the firearm.

21. The precision guided firearm system of claim 20, wherein the optical device provides a reticle to the display and controls the trigger assembly to prevent discharge of the firearm until a center of the reticle is aligned to the visual marker.

22. The precision guided firearm system of claim 16, wherein the optical device comprises an input/output interface configured to receive the user input from at least one of a user-selectable element on the firearm, a user-selectable element on the optical device, and a computing device.

23. The precision guided firearm system of claim 22, wherein the user input comprises a signal corresponding to at least one of a button press and a button release when a center of a reticle is aligned to the visual marker within the sequence of video frames.

24. The precision guided firearm system of claim 22, wherein the optical device is configured to receive a mode selection input indicating the group shooting mode through the input/output interface.
